(19) United States
(12) Patent Application Publication
(10) Pub. No.: US 2004/0129370 A1
(43) Pub. Date: Jul. 8, 2004

(54) Joining material

(76) Inventors: Alan Taylor, Cambridge (GB); John Andrew Fernie, Cambridge (GB); Paul Jackson, Cambridge (GB); Caroline Williams, Cambridge (GB)

Correspondence Address: Dickstein Shapiro, Morin & Oshinsky, 41st Floor, 1177 Avenue of the Americas, New York, NY, 10036-2714, US

(21) Appl. No.: 10/250,900

(22) PCT Filed: Jun. 10, 2002
(86) PCT No.: PCT/GB02/02647

(30) Foreign Application Priority Data
Jun. 8, 2001 (GB) 0114009.4

(51) Int. Cl. B32B 9/00; B32B 19/00

(52) U.S. Cl. 156/89.11; 428/689; 156/89.16

(57) ABSTRACT

A process for joining at least two substrates together comprises applying between the substrates a composition comprising a liquid pre-ceramic binder and at least one other component selected from a metal powder, a metal oxide powder and mixtures thereof, and pyrolysing the composition, to form a join between the two substrates, the join comprising a mixed metal oxide. The composition is capable of joining together a wide variety of substrates, without failure, after exposure to high temperature.

### FIELD OF THE INVENTION

The invention relates to a joining material which finds particular use in joining substrates, especially ceramic substrates, which are to be exposed to very high temperatures, such as those encountered in power-generating equipment.

### BACKGROUND TO THE INVENTION

A variety of ceramic adhesives are known in the art for high temperature applications. Typically, these are based on silicates or phosphates, and can withstand temperatures in the range 1200 to 1300° C. Commercially-available examples include those available from AREMCO under the trade names AREMCO Cerama-bond 503 and AREMCO Ultra-Temp 516. However, a problem with these kinds of adhesive is that they tend to fail, i.e. crack, in environments combining high temperature and stress.

Another silicate-based adhesive is available from Fortafix Limited, UK, under the trade name Chromix, and is capable of withstanding temperatures of up to 1600° C. However, Chromix is generally unsuitable for joining ceramic substrates, as it contains silica, a recognised ceramic poison.

P. Columbo et al, Journal of Nuclear Materials (2000) 278: 127-135, describe a different approach in which silicon carbide composites are joined together by a silicon-oxycarbide ceramic material formed by pyrolysis, in an inert atmosphere, of a pre-ceramic polymer comprising a silicone resin and aluminium/silicon powder. However, the bond strength is reported to be unsatisfactory.

GB-A-2263430 describes a method of solid-state bonding a metal substrate to an alumina substrate comprising coating the alumina substrate with a magnesium-containing alloy layer, heating the two substrates, and pressing them together, to form a reaction bonded layer presumed to comprise spinel and at least one material selected from alumina, magnesia, aluminium and oxygen. However, from the reaction conditions described, it would seem unlikely that spinel was formed. The resulting metal-alumina bonded material is then further bonded to another metal material by a metallurgical bonding technique, for example diffusion bonding, welding or soldering, or by a mechanical bonding technique, for example interference, or shrink, fitting. A disadvantage with the bonding method described in this document is its limited applicability, to the bonding of metals to alumina substrates, and to an operational temperature range dictated by the magnesium-alloy containing layer.

Therefore, there is a need for an alternative high temperature adhesive, or joining material, which does not suffer from the aforementioned problems.

### SUMMARY OF THE INVENTION

According to a first aspect of the present invention, a process for joining at least two substrates together comprises applying between the substrates to be joined a composition comprising a liquid pre-ceramic binder and at least one other component selected from a metal powder, a metal oxide powder and mixtures thereof, and pyrolysing the composition to form a join between the two substrates, the join comprising a mixed metal oxide.

According to a second aspect of the present invention, an article comprises at least two substrates joined together by a join obtainable by pyrolysing the above-described composition.

Third and fourth aspects of the present invention are directed to the use of the above-described composition as a joining material capable of bonding a wide variety of substrates, without failure, after exposure to high temperature, and to certain compositions per se.

### DESCRIPTION OF THE INVENTION

The composition to be used as the joining, or bonding, material of the present invention comprises a liquid pre-ceramic binder and at least one other component selected from a metal powder, a metal oxide powder and mixtures thereof.

In the context of the present Application, the term “pre-ceramic” is intended to embrace any material which, on pyrolysis, forms a ceramic material. The pre-ceramic binder for use in the present invention may be any binder which, on pyrolysis decomposes and interacts with the metal powder and/or a metal oxide powder included in the composition, to form a mixed metal oxide. The pre-ceramic binder is liquid in nature, but may vary considerably in viscosity, taking the form of a paste, slurry or solution, depending on the concentration of active binder material and any medium in which this is dispersed or dissolved. By “active binder material” it is meant that material which, on pyrolysis, actually interacts with the metal powder and/or metal oxide powder.

Examples of pre-ceramic binders which may find use in the present invention include silicones, aluminium nitrate nonahydrate, aluminium chlorohydrate, magnesium nitrate nonahydrate, magnesium chloride hexahydrate and mixtures thereof. Although other aluminium and/or magnesium-containing pre-ceramic binders may be envisaged.

Silicones suitable for use as binders in the present invention include silicone polymers comprising organic groups bonded to their silicon atoms, which will usually be alkyl or aryl groups, or a combination thereof. Commercially-available silicone materials useful in the present invention include silicone sealants typically used in bathroom applications, such as Dow Corning 781 Acetoxy Silicone Sealant. Such sealants typically include solvent in addition to a silicone polymer, to aid handling.

Typically, the aluminium- and magnesium-containing binders are used in the form of aqueous slurries or solutions. In this case, the amount of active binder material and water must be controlled to achieve adequate reaction and yet minimise shrinkage on evaporation, as the latter may cause cracking of the resulting join. Therefore, the concentration of active binder material used will depend on the nature of the other components in the composition, and the substrates to be joined. Typically, the concentration of active binder material in water will lie in the range 10-95 weight %, for instance 40 to 90 weight %, or 60 to 85 weight %. Generally, however, it is preferred to use a solution which is close to, or at, saturation with the active binder material.

The metal powder or metal oxide powder may be any metal or metal oxide which will produce a mixed metal oxide on pyrolysis with the pre-ceramic binder. In the context of the present Application, such metal or metal oxide powders are referred to as “reactive” powders, and the term “metal” is intended to include silicon. Examples of suitable metals include aluminium, titanium, zirconium, magnesium and mixtures thereof. Examples of suitable metal oxides include alumina, magnesia, talc (3MgO.4SiO₂.H₂O), kaolin, silica, other ceramic materials reactive with the pre-ceramic binder to form a mixed metal oxide, and mixtures thereof.

In the context of the present Application the term “powder” includes any particulate material having sufficient surface area to react with the pre-ceramic binder. Typically, the powder has a particle size up to about 30 μm, preferably up to about 20 μm and more preferably up to about 10 μm.

Naturally, different combinations of pre-ceramic binder and metal and/or metal oxide powder will, on pyrolysis, give rise to different mixed metal oxides.

In certain cases, it may be necessary, or desirable, to use a mixture of metal powders and/or metal oxide powders. For instance, while the pre-ceramic binder typically provides at least one of the species to be incorporated into the mixed metal oxide, this species may not be present in sufficient amount in the binder per se. Therefore, it may need to be supplemented by the use of an appropriate metal and/or metal oxide powder.

The pyrolysis conditions themselves, and in particular the temperature used and the time for which this is applied, may also affect the nature of the material obtained, for instance giving rise to mixtures of mixed metal oxides or to intermediates en route to a mixed metal oxide recognised in the art. Examples of mixed metal oxides that may be formed include mullite, the magnesium alumina silicate cordierite, the magnesium aluminium oxide spinel, and mixtures thereof. Formation of these mixed metal oxides may be confirmed by X-ray diffraction.

The choice of combination of pre-ceramic binder and metal/metal oxide powder is primarily determined by the nature of the substrate, and in particular whether the substrate can withstand the pyrolysis conditions necessary to form the resulting mixed metal oxide. According to the literature (Treadwell et al, Chem. Matter (1996) 8: 2056-2060), mullite may be formed at a temperature as low as about 980° C. Although, in practice, in order to obtain sufficient mullite to form a strong join, on a commercially-acceptable time-scale, for example up to 48 hours, significantly higher temperatures must be used. For instance, typically, a temperature of at least 1400° C. will need to be used, and often higher, for example up to, or in excess of, 1600° C. Thus, only substrates capable of withstanding these extreme temperatures may be joined by the in situ formation of mullite. In this case, the pre-ceramic binder will typically comprises a silicone resin and this will be mixed, at least, with aluminium powder. If magnesium is also included in the mixture, pyrolysis results in the magnesia alumina silicate cordierite, although different pyrolysis temperatures may be appropriate for formation of this mixed metal oxide.

For substrates not capable of withstanding the high temperatures necessary for the formation of mullite it is preferred that the joining material comprise spinel, as this can be formed, on a commercially-acceptable time-scale, at temperatures as low as 1000° C. In this case, the pre-ceramic binder is selected from aluminium- and magnesium-containing binders which, in turn, are mixed with magnesium- and/or aluminium-containing powders, respectively, in order to give rise to spinel. For instance, when the pre-ceramic binder comprises aluminium chlorohydrate or aluminium nitrate nonahydrate a source of reactive magnesium must be provided, whereas when the pre-ceramic binder is magnesium nitrate nonahydrate or magnesium chloride hexahydrate a reactive source of aluminium must be provided.

Examples of particularly preferred joining compositions of the present invention include combinations of an aluminium chlorohydrate binder and talc, and optionally alumina; an aluminium nitrate nonahydrate binder and magnesia or talc, and optionally alumina; and a binder comprising magnesium chlorohexahydrate or magnesium nitrate nonahydrate with alumina, and optionally a source of reactive magnesium, such as magnesia or talc.

The choice of combination of pre-ceramic binder and metal and/or metal oxide may also be influenced by the ease of control of the kinetics of reaction between the materials. For example, if the precursor composition comprises aluminium chlorohydrate as the binder, it is generally not desirable to combine this with magnesia, as the reaction between the two materials is difficult to control. In such a case, talc is preferentially used in place of magnesia. Although, as talc contains silica, which is recognised as a poison for ceramic composites, in that it diffuses into their structure and forms a glassy state therein, thereby weakening their structure, this combination of materials is less preferred for joining ceramic composites. Therefore, for such composites, it is preferred to use a different pre-ceramic binder and metal and/or metal oxide combination, such as aluminium nonohydrate and magnesia, optionally with alumina, or one of the above magnesium-containing pre-ceramic binders and alumina, optionally with magnesia.

The precise proportions of pre-ceramic binder and metal and/or metal oxide powder will depend upon the desired mixed metal oxide, and the particular combinations of materials selected to achieve that mixed metal oxide. Generally, however, the amount of liquid pre-ceramic binder should be sufficient to form a homogeneous paste or slurry on mixing with the other components of the composition. Typically, the amount of active binder material included in the precursor composition will comprise 5 to 50 weight %, and more preferably 15 to 40 weight %, of the total weight of the unpyrolysed, or wet, composition.

The reactive metal and/or metal oxide powder, and any medium included in the pre-ceramic binder, may make up the balance of the composition. Generally, the reactive metal and/or metal oxide powder will be used in a stoichiometric amount with the binder, or in an excess thereof, to obtain the desired mixed metal oxide. In this sense, in determining the amount of metal and/or metal oxide powder to be used, the amount of any reactive species present in the binder per se should be taken into account, particulary where such reactive species have been supplemented through the use of additional metal and/or metal oxide powders.

Where, however, the pre-ceramic binder comprises a silicone, it is generally preferred to use an excess of metal powder so as to ensure complete decomposition of the silicone, and conversion to a mixed metal oxide, e.g. mullite, on pyrolysis. This is because if, after pyrolysis, any silica remains, this may cause cracking of the product on exposure to high temperature.

The composition of the present invention may also comprise an inorganic filler, which may take the form of a powder and/or fibrous material. The filler is essentially inert, in that in the presence of the metal and/or metal oxide powder it does not substantially react with the pre-ceramic binder. The filler may be any material capable of adding functionality or adjusting the properties of the mixed metal oxide formed on pyrolysis. Suitable materials include those which vary the thermal conductivity and thermal expansion properties of the joining material, for instance so as to match that of substrates being joined. Examples include alumina, magnesia, silica, zirconia, ceria, hafnia, aluminium silicates, such as mullite, vermiculite, silicon carbide, silicon nitride, aluminium nitride, and mixtures thereof. Typically, the filler particle size is in the range 30-500 μm, and is typically larger than any reactive metal and/or metal oxide powder included in the composition.

Typically, a filler may be included in an amount of up to 85 weight %, preferably 40 to 70 weight %, more preferably 45 to 60 weight %, based on the total weight of the unpyrolysed, or wet, composition.

In use, the composition is formed by mixing together the pre-ceramic binder, the metal and/or metal oxide and any filler present to form a slurry or paste. This is then applied between the two or more substrates to be joined together, either by application to one or each of those substrates. The substrates are then brought together, and the composition subjected to heat so as to pyrolyse the composition.

As alluded to earlier, the temperature at which pyrolysis is carried out will depend on the composition, the desired reaction product, and/or the amount of that reaction product required to form a join. For example, if the mixed metal oxide to be formed is spinel, lower temperatures will typically be required than if mullite or cordierite, for example, is to be formed. Typically, heating to a temperature of at least 1000° C. will be required, although at the lower end of this temperature range extended periods of heating may be required to obtain the desired reaction product. Accordingly, it is preferred to use temperatures in excess of this, for instance of at least 1200° C., more preferably of at least 1300° C., and most preferably of at least 1400° C., and generally the higher the temperature the stronger the join strength.

Heating is typically conducted in an oxygen-containing atmosphere, for example in air, typically in an oven or furnace, although other conventional heating techniques may be used, for instance microwave, radio frequency induction, or power beam radiation.

The composition of the present invention may be used to join together a wide variety of substrates, including metals, ceramics and composites, preferably ceramics and composites, and more preferably oxide-oxide ceramics, whether as one or more of the substrates to be joined. The composition is useful in any of the applications in which the present-day high temperature ceramic adhesives find use. However, the composition of the present invention is particularly useful in applications in the aerospace industry and the power-generating industry, for instance joining heat resistant products to aircraft; power-generating equipment and parts thereof, for example, combustion chambers; furnace linings; and heat exchangers. Such heat-resistant products include ceramic materials, high temperature metallic materials, e.g. nickel alloys and titanium alloys, and other forms of thermal barrier coating, preferably ceramics, more preferably oxide-oxide ceramic materials. Examples include those described in WO-A-9959935 and U.S. Pat. No. 6,013,592.

The present invention is now further illustrated by way of reference to the following Examples.

### EXAMPLE 1

25 g of silicone bath sealant (Dow Corning 781 Acetoxy Silicone Sealant) were mixed with 25 g of acetic acid. To this mixture were then added 25 g Fine Aluminium Powder (from Riedel de Haen, Germany), and mixing was continued to produce a homogeneous paste.

The paste was applied to the surface of an alumina plate, and the surface of another alumina plate was then brought into contact with the paste, and the resulting sandwich was pressed tightly together, removing any excess paste exuding from the sides thereof. This structure was then dried in air overnight, to allow the acetic acid to evaporate, and was then cured in a standard air furnace at 1600° C. for two hours.

The result was a strong join formed between the two alumina plates.

### EXAMPLE 2

Three powder mixtures each comprising 14 g coarse alumina, 6 g fine alumina and 1 g magnesia were prepared. To each powder mixture was added one of the following quantities of liquid pre-ceramic binder:

Composition 1: 8.4 g of a 71 weight % solution of aluminium nitrate nonahydrate in water

Composition 2: 11 g of a 61 weight % solution of magnesium nitrate nonahydrate in water

Composition 3: 12 g of a 80 weight % solution of magnesium chloride hexahydrate in water.

Composition 4, comprising 13 g coarse alumina, 5 g fine alumina, 4 g talc and 13 g of a 50 weight % solution of aluminium chloride hexahydrate in water was prepared in a similar way.

Each of the resulting four pastes was applied to one surface of four separate alumina plates. The coated surfaces of pairs of plates were then brought into contact with one another such that two sandwich structures each comprising two plates coated with the same paste were assembled for each of the four compositions. These sandwich structures were pressed tightly together, removing any excess paste exuding from the sides thereof, and cured using the following temperature profile:

Step 1: Room temperature to 60° C. at a rate of 2° C./min. Hold at 60° C. for 8 hour.

Step 2: 60° C. to 120° C. at a rate of 2° C./min. Hold at 120° C. for 8 hour.

Step 3: 120° C. to either 1275° C. or 1600° C. at a rate of 2° C./min. Hold at 1275° C. or 1600° C. for 3 hour.

Step 4: Cool to room temperature at a rate of 2° C./min.

Joins were formed between the alumina plates after curing at both 1275° C. and 1600° C., with stronger bonds being formed at the higher curing temperature. Join strength was measured by a lap-shear test using a tensometer.

The joins formed at 1600° C. were compared with a join formed using Chromix (supplied by Fortafix Limited), which had been subjected to the same temperature profile. The join strengths obtained are shown in Table 1, below.

TABLE 1

| Joining Material | Join Strength (MPa) |
|---|---|
| Chromix | 1.40 |
| Composition 1 | 1.05 |
| Composition 2 | 1.25 |
| Composition 3 | 0.70 |
| Composition 4 | 1.15 |

Thus, the compositions according to the present invention represent a viable alternative to Chromix. Furthermore, as, unlike Chromix, a number of the compositions of the present invention do not contain silica, they are more suitable for joining together ceramic substrates, where the presence of silica has a deleterious effect on the strength of such substrates.

1. A process for joining at least two substrates together, the process comprising applying between the substrates to be joined a composition comprising a liquid pre-ceramic binder and at least one other component selected from a metal powder, a metal oxide powder and mixtures thereof, and pyrolysing the composition to form a join between the two substrates, the join comprising a mixed metal oxide.

2. A process according to claim 1, wherein the mixed metal oxide is selected from mullite, cordierite, spinel, and mixtures thereof.

3. A process according to claim 1 or claim 2, wherein the liquid pre-ceramic binder comprises a material selected from silicones, aluminium-containing pre-ceramic materials and magnesium-containing pre-ceramic materials.

4. A process according to claim 3, wherein the liquid pre-ceramic binder comprises a material selected from aluminium chlorohydrate, aluminium nitrate nonahydrate, magnesium chloride hexahydrate, magnesium nitrate nonahydrate and mixtures thereof.

5. A process according to claim 3, wherein the composition comprises a silicone binder and a metal powder.

6. A process according to any preceding claim, wherein the composition comprises a metal powder selected from aluminium, titanium, zirconium, magnesium and mixtures thereof.

7. A process according to claim 5, wherein the metal powder is aluminium or a mixture of aluminium and magnesium.

8. A process according to claim 4, wherein the composition comprises an aluminium chlorohydrate binder and talc.

9. A process according to claim 4, wherein the composition comprises an aluminium nitrate nonahydrate binder and a metal oxide selected from magnesia, talc and mixtures thereof.

10. A process according to claim 8 or claim 9, wherein the composition additionally comprises alumina.

11. A process according to claim 4, wherein the composition comprises a binder selected from magnesium chloride hexahydrate and magnesium nitrate nonahydrate; a metal oxide selected from magnesia, talc and mixtures thereof; and alumina.

12. A process according to any preceding claim, wherein the composition additionally comprises an inert filler.

13. A process according to any preceding claim, wherein at least one of the substrates comprises a ceramic material.

14. A process according to claim 13, wherein each substrate comprises a ceramic material.

15. A process according to claim 13 or claim 14, wherein the or each ceramic material comprises an oxide-oxide ceramic material.

16. A process according to any of claims 1 to 13, wherein at least one of the substrates comprises a high temperature metallic material.

17. A process according to any of claims 1 to 13 and 16, wherein one of the substrates belongs to an article selected from an aircraft; power-generating equipment; a furnace lining; and a heat-exchanger.

18. An article comprising at least two substrates joined together by a join obtainable by a process as defined in any preceding claim.

19. An article comprising at least two substrates joined together by a mixed metal oxide.

20. An article according to claim 19, wherein the mixed metal oxide is mullite or cordierite.

21. An article according to claim 19, wherein the mixed metal oxide is spinel.

22. An article according to any of claims 18 to 21, which is selected from aircraft; power-generating equipment and parts thereof; furnace linings; and heat exchangers.

23. An article according to claim 22, which is a combustion chamber.

24. Use as a joining material of a composition as defined in any of claims 1 to 12.

25. A composition comprising an aluminium chlorohydrate binder and talc.

26. A composition comprising an aluminium nitrate nonahydrate binder and a metal oxide selected from magnesia, talc and mixtures thereof.

27. A composition according to claim 25 or claim 26, which additionally comprises alumina.

28. A composition comprising a binder selected from magnesium chloride hexahydrate and magnesium nitrate nonahydrate; a metal oxide selected from magnesia, talc and mixtures thereof; and alumina.

29. A composition according to any of claims 25 to 28, which additionally comprises an inert filler.
